(19) United States
(12) Patent Application Publication
(10) Pub. No.: US 2015/0171786 A1
(43) Pub. Date: Jun. 18, 2015

(54) SOLAR PANEL SUPPORTS

(71) Applicant: Andrew B. Worden, New York, NY (US)

(72) Inventor: Andrew B. Worden, New York, NY (US)

(21) Appl. No.: 14/144,488

(22) Filed: Dec. 30, 2013

Related U.S. Application Data
(60) Provisional application No. 61/746,702, filed on Dec. 28, 2012.

(51) Int. Cl. H02S 20/10; H02S 20/20

(52) U.S. Cl. CPC H02S 20/10; H02S 20/20

(57) ABSTRACT

A solar panel support system comprising a plurality of solar panels supportingly engaged with and connected to ledges of U-shaped weighted support pans of different heights. The ledges are perforated with at least two threaded apertures wherein edges of adjacent slightly spaced apart solar panels supported on a ledge of a support pan are spanned by an apertured hold down element. One of the threaded apertures is accessible, through a spacing between the slightly spaced apart solar panels, to a bolt which passes through the hold down element and into threaded engagement with the one of the threaded apertures with hold down engagement of the adjacent panels to a ledge of the pan being effected with the threaded engagement of the bolt and the threaded aperture.

This application claims benefit of provisional patent application Ser. No. 61/746,702, filed Dec. 28, 2012, entitled Solar Panel Supports, the disclosure of which is incorporated herein in its entirety by reference thereto.

### FIELD OF THE INVENTION

This invention relates to elements and methods used in the production, installation and use of supports utilized for supporting solar panels for collection of solar energy and particularly to methods and elements used in facilitating rapid and proper installation of solar panels on rooftops and ground, including compensation for environmental factors.

### BACKGROUND

Solar panels provide a renewable and environmentally acceptable source of energy and their use has become increasingly popular with increased installations. Solar panels are comprised of two basic parts, the collectors which collect sunlight and convert it into usable energy and the support for such collectors which must be environmentally stable since the solar panels are perforce exposed to the elements.

A good general description of solar panels and the state of the art of support systems used therewith is found in the current Wikipedia entry on the subject of solar panels. A solar panel is a set of solar photovoltaic modules electrically connected and mounted on a supporting structure. A photovoltaic module is a packaged, connected assembly of solar cells. The solar module can be used as a component of as larger photovoltaic system to generate and supply electricity in commercial and residential applications. Each module is rated by its DC output power under standard test conditions (STC), and typically ranges from 100 to 320 watts. The efficiency of a module determines the area of as module given the same rated output—an 8% efficient standard 230 watt module will have twice the area of a 16% efficient 230 watt module. Since a single solar module can produce only a limited amount of power, most installations contain multiple modules. A photovoltaic system typically includes a panel or an array of solar modules, an inverter, and sometimes a battery and/or solar tracker and interconnection wiring.

The solar panels are generally mounted in, either tracking systems, adapted to move and track sunlight, or in fixed rack configurations with fixed racks which hold modules stationary as the sun moves across the sky. The fixed rack sets the angle at which the module is held. Tilt angles equivalent to an installation's latitude are common. Most of these fixed racks are set on poles embedded in a base. These fixed rack configuration systems are commonly broken down into ground mounted systems and roof mountings with differing installation requirements.

Ground mounted solar power systems consist of solar modules held in place by racks or frames that are attached to ground based mounting supports.

Ground based mounting supports include:
Pole mounts, which are driven directly into the ground or embedded in concrete.
Foundation mounts, such as concrete slabs or poured footings
Ballasted footing mounts, such as concrete or steel bases that use weight to secure the solar module system in position and do not require ground penetration. This type of mounting system is well suited for sites where excavation is not possible such as capped landfills and simplifies decommissioning or relocation of solar module systems.

Roof-mounted solar power systems consist of solar modules held in place by racks or frames attached to roof-based mounting supports.

Roof-based mounting supports include:
Pole mounts, which are attached directly to the roof structure and may use additional rails for attaching the module racking or frames.
Ballasted footing mounts, such as concrete or steel bases that use weight to secure the panel system in position and do not require through penetration. This mounting method allows for decommissioning or relocation of solar panel systems with no adverse effect on the roof structure.
All wiring connecting adjacent solar modules to the energy harvesting equipment must be installed according to local electrical codes and should be run in a conduit appropriate for the climate conditions

The Solar Panels themselves of standard 200-250 Watts are of 5-6 feet (or slightly less than about 2 meters) in length and 3.5 feet (slightly more than about a meter) in width and can weigh as much as 25 kg (about 55 lbs). Solar Arrays are made up of a number of Solar Panels, which provide the required voltage and power for electricity requirements.

Because of the size and sheer number of panels required for module arrays, the individual mounting of the large panels in fixed room and ground installations is difficult and often tedious with improper or less than optimal installations, particularly in view of external environmental effects, being common.

### SUMMARY OF THE INVENTION

It is accordingly an object of the resent invention to provide methods and elements to facilitate the rapid yet operationally proper installation of solar panels in roof and ground mounting solar panel systems.

It is a further object of the present invention to provide a ground mounting system with the ability to compensate for variations in ground level conditions

Generally the present invention comprises a method utilizing elements to facilitate the installation of solar panels in a roof mounting system. Steel pans are used which provide tilt support for the solar panels. Mounting of solar panels to the steel pans is facilitated to be effected from only a one side, top anchoring, with peripheral mounting elements configured to provide a more secure mounting with effective grounding. The invention further comprises support elements for ground installation systems, which readily compensate for ground irregularities while maintaining proper angled position.

The invention comprises a solar panel support system comprising a plurality of solar panels supportingly engaged with and connected to ledges of U shaped weighted support pans of different heights. The ledges of the pans are each perforated with at least two threaded apertures. Edges of adjacent slightly spaced apart solar panels supported on a ledge of a support pan are spanned by an apertured hold down element. One of the threaded apertures is accessible, through a spacing between the slightly spaced apart solar panels, to a bolt which passes through the hold down element and into threaded engagement. with the one of the threaded apertures. Hold down engagement of the adjacent panels to a ledge of the pan is effected with the threaded engagement of the bolt and the threaded aperture.

In a roof mounting system U-shaped steel pans with peripheral solar panel supporting ledges of different levels are used to support edges of the solar panels at the requisite angular tilt for efficiently catching solar rays. The pans are also configured to accommodate ballast such as concrete blocks in the respective U sections thereof. The ballast is used in order to hold down the array under wind or other environmental conditions to which the roof top emplaced array of panels is exposed. Connection of the solar panels to the supporting steel pans with a stable and solid connection is essential but such connection often entails numerous manual placements with awkward and often difficult access being required to all sides (including from the hard to reach underside of the pan edges) in order to effect the standard nut anchoring.

In accordance with the present inventions, the supporting ledges of the steel pans on which the solar panels are angularly placed in an array configuration are provided with apertures having internal threads. With a roof support installation, individual solar panels are abutted with slight separations on a single pan with threaded apertures on the supporting ledges being positioned between the panels. The pans are provided with numerous of such apertures to enable placement variations. With such internal threading the solar panels are fixedly attached to the supporting pans by means of bolts passing through apertured panel hold-down elements, which straddle an upper area between panels and peripheral frame edges of the panels. An end-of-panel hold down element is differently configured to provide its own stable support. The bolts are then passed through the apertures in the respective hold down elements to engage the threaded aperture in the supporting ledges of the pans and are tightened against the internal threads of the pan aperture to effect the requisite stable support.

With numerous arrays it is highly preferred that the pans at both upper and lower edges of the panels be properly aligned for exposure of aligned threaded apertures for bolt threading engagement. In order to effect such alignment in both horizontal and vertical directions it is preferred that the pans be solidly linked with snap-in-strip elements configured to matingly engage elements and apertures in the sides of the U shape of the pans. Parallel linked pans provide facilitated placement and installation.

In some embodiments a separate flat elements with extending teeth and a central aperture, is positioned in between and in line with the between panel hold down elements and the solar panels and with the central aperture of the separate flat element being aligned with the respective apertures of the hold down element and the ledge support of the pan. The teeth are positioned to electrically connect to the solar panel edges to provide a safety grounding element.

The panel hold down elements are preferably configured to directly engage the pan ledge with the contacting edge of the panel hold down element having similar teeth to provide a similar grounding function without the optional flat element.

In a ground solar panel installation, in accordance with another embodiment of the present invention instead of the supports for the solar panels being imbedded in the ground, U-shaped tubular base elements are utilized to provide the support for the panels with the tubular base elements. Because of their respective circular configurations, the tubular base can be readily rotated with the supporting flat base being tilted to accommodate around irregularities while maintaining upright support for the solar panels. The tubular base is clamped down into position on the flat base support, with the flat base support having threaded apertures for insertion and tightening of a clamping member. This permits the adjustment of the tubular base elements without the need for clamping thereof requiring access from beneath the flat base support. Alternatively, the flat base support is pre provided with upwardly extending bolt elements which fit into clamps with fasten down nuts to effect the clamping.

Other objects, features and advantages of the present invention will become more evident from the following discussion and drawings in which:

### SHORT DESCRIPTION OF THE DRAWINGS

FIG. 1 is a perspective view of an array of a number of solar panels in is roof installation;

FIG. 2 is a perspective view of an initial U-shaped support pan as used in the solar panel array of FIG. 1;

FIG. 3A is a front view of three pans of FIG. 2, as connected and aligned with a snap-in connector element;

FIG. 3B is an enlarged view of the center-connected pan of FIG. 2 showing the snap-in connection elements;

FIG. 4 is a perspective view of a hold down element as used between abutted but separated panels;

FIG. 5A shows the use of the hold down element of FIG. 4 as positioned far use between solar panels and With bolt and washer element;

FIG. 5B shows the hold down element of FIGS. 4 and 5A as fully installed between adjacent solar panels with the holding down of such panels on a pan;

FIG. 6 is an end solar panel hold down element with position buttressing and stabilization extension;

FIGS. 6A and 6B show the similar hold down of an end panel as compared to FIGS. 5A and 5B;

FIG. 7 is an optional toothed element configured for placement between the hold down element in FIGS. 4, 5A and 5B and the edges of solar panels shown in FIGS. 5a and 5B to provide a safety ground;

FIG. 8 is a tubular base section of a ground solar panel system after hold down clamping; and

FIGS. 8A and 8B show the attachment of the tubular base section of FIG. 8 with adjustment for ground unevenness shown by the arrows.

### DETAILED DESCRIPTION OF THE INVENTION AND DRAWINGS

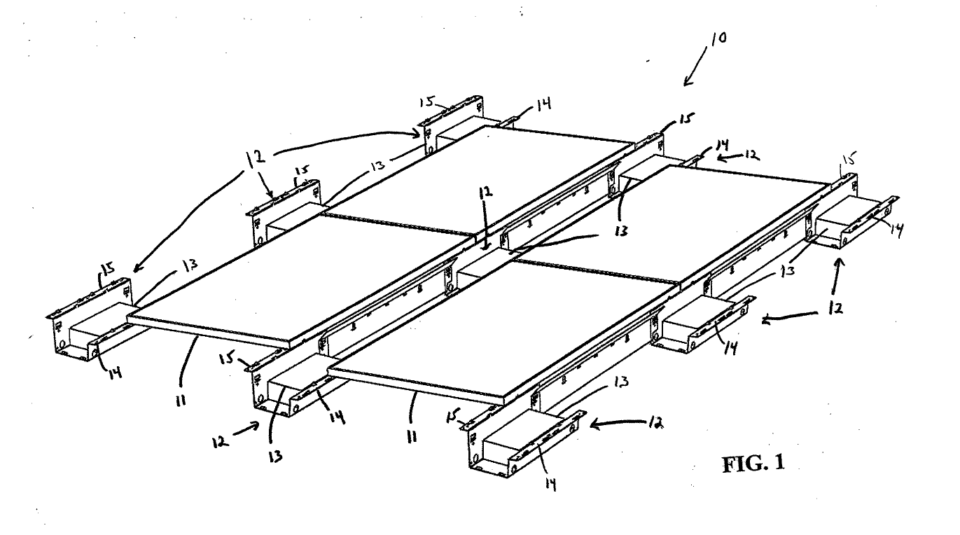

With respect to the drawings, FIG. 1 depicts a roof solar panel installation 10 with laterally abutted solar panels 11 with edges alternately resting on support ledges 14 and 15 of pans 12. Concrete block ballasts 13 hold the installation down with added weight. The difference in heights of ledges 14 and 15 provides the requisite angled positioning of the panels or facilitated collection of sun rays.

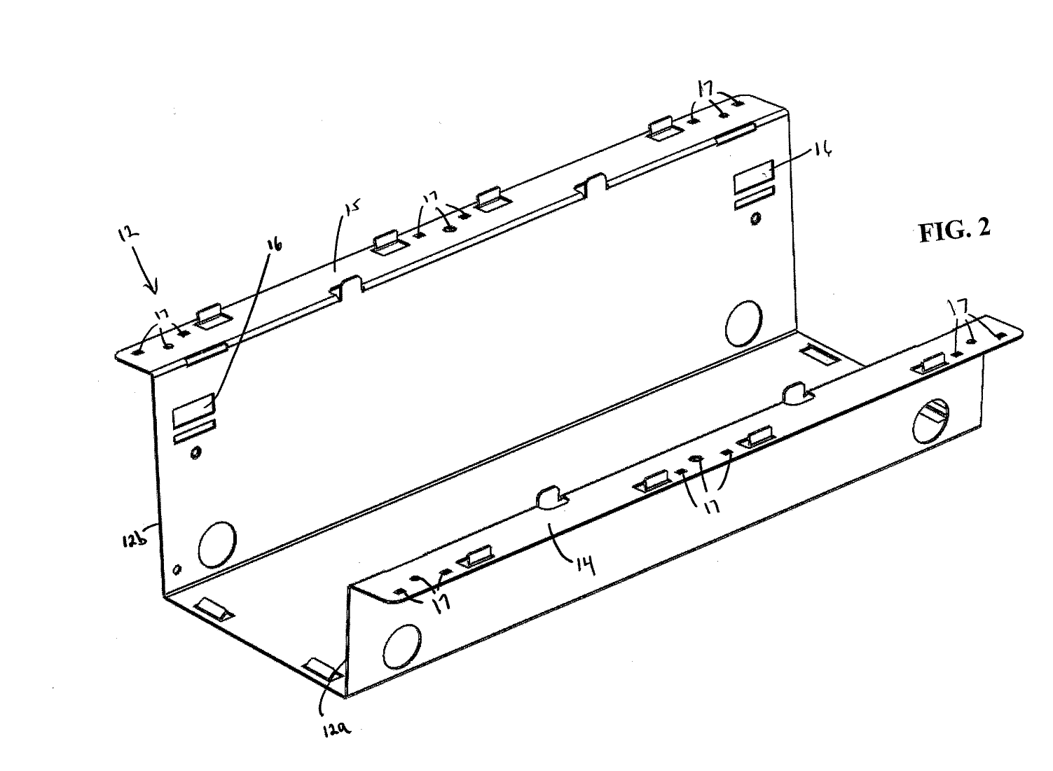

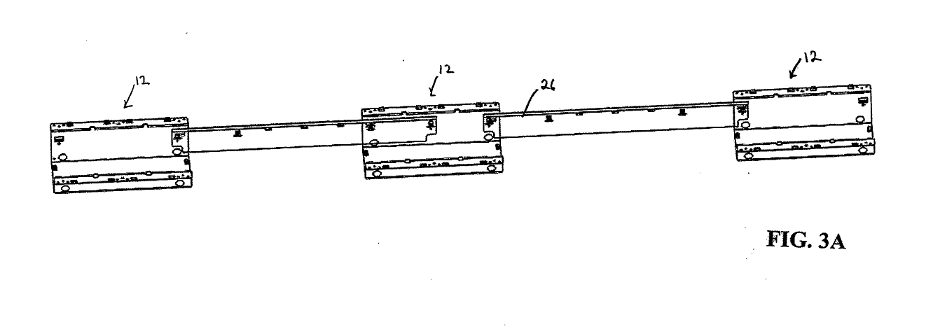

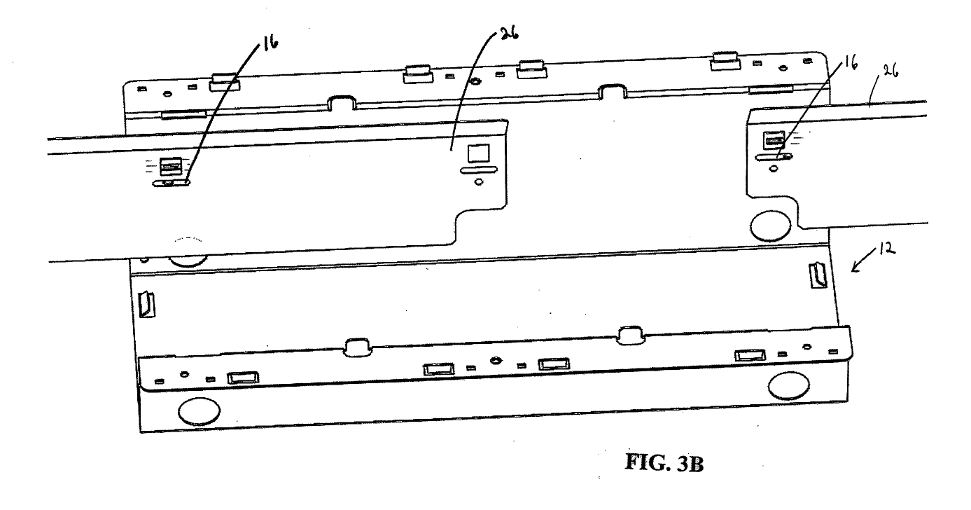

Support pan 12 in FIGS. 2, 3A and 3B is shown with threaded apertures 17 and clip apertures 16. Clip apertures 16 engage clip elements in connector strip 26 (FIGS. 3A and 3B) for the secure connection therewith, as shown in FIG. 3A with the three pans shown being positioned at predetermined intervals.

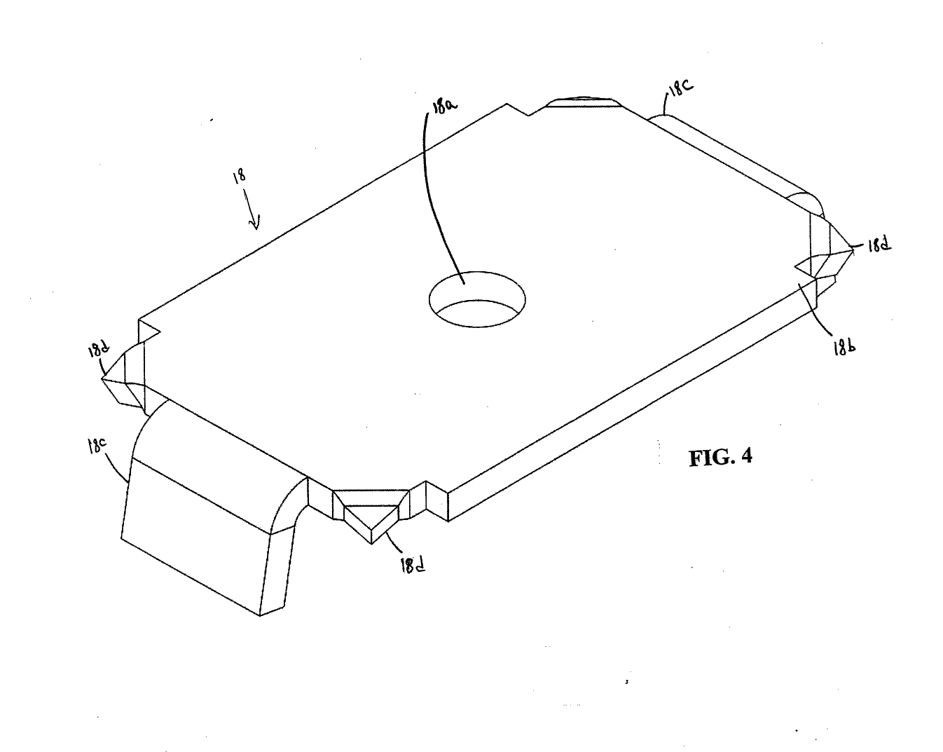

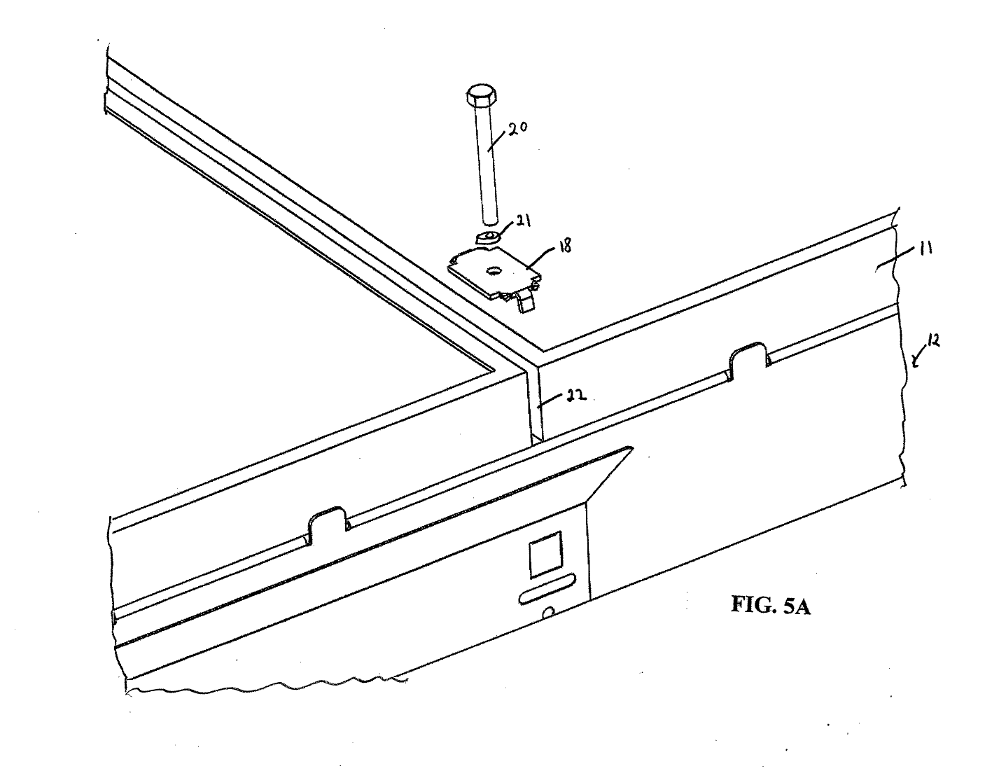

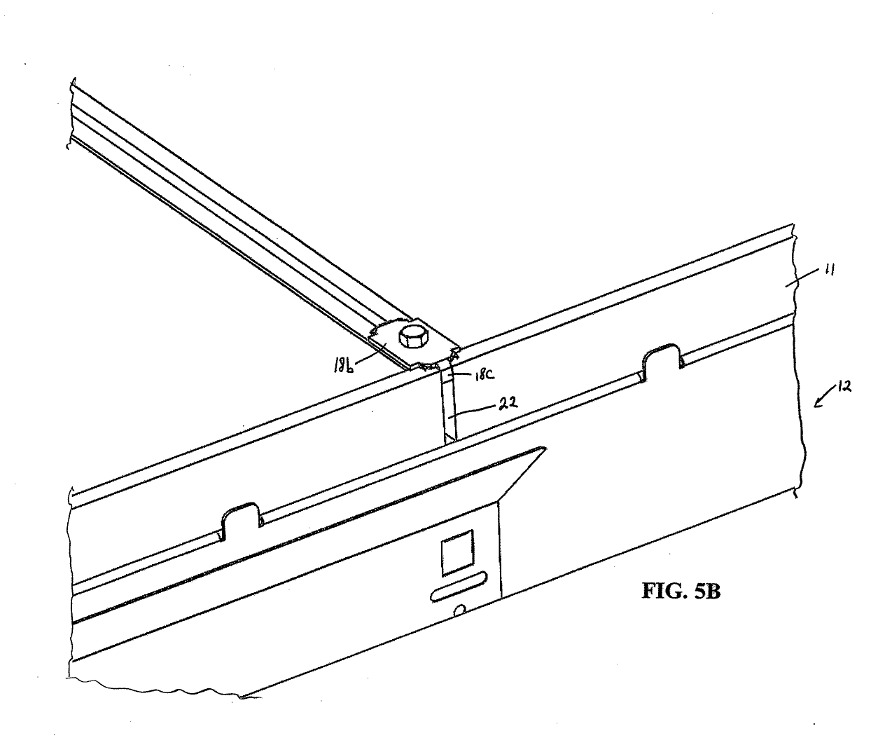

A pair of closely abutted solar panels 11 are shown in FIGS. 5A and 5B with a slight separation 22 therebetween. Hold down element 18, shown in FIG. 4, is positioned on top of the edges of the abutted panels 11 with downwardly extending tongues 18c snugly fitted into the separation 22, as a position fixing spacer. Bolt 20 (with washer 21) fitted into aperture 18a and extends downward, though not shown into threaded engagement with a threaded aperture 17 of the ledge 15, on which the edge of solar panels 11 are resting (the same effect is applicable to panel edges resting on ledges 14). Tightening of bolt 20 causes flat edge extensions 18b to engage adjacent edges of solar panels 11 to tightly hold them on the pan ledge 15. If desired, toothed section element 30 can be interposed between hold down element 18 and the edges of the solar panel 11 wherein the teeth 31 thereof electrically connect with the solar panels 11 to provide a safety ground. Alternatively, to eliminate this separate element, hold down element 18 is provided with downwardly extending teeth 18d which electrically engage the solar panels 11 to provide the requisite safety ground.

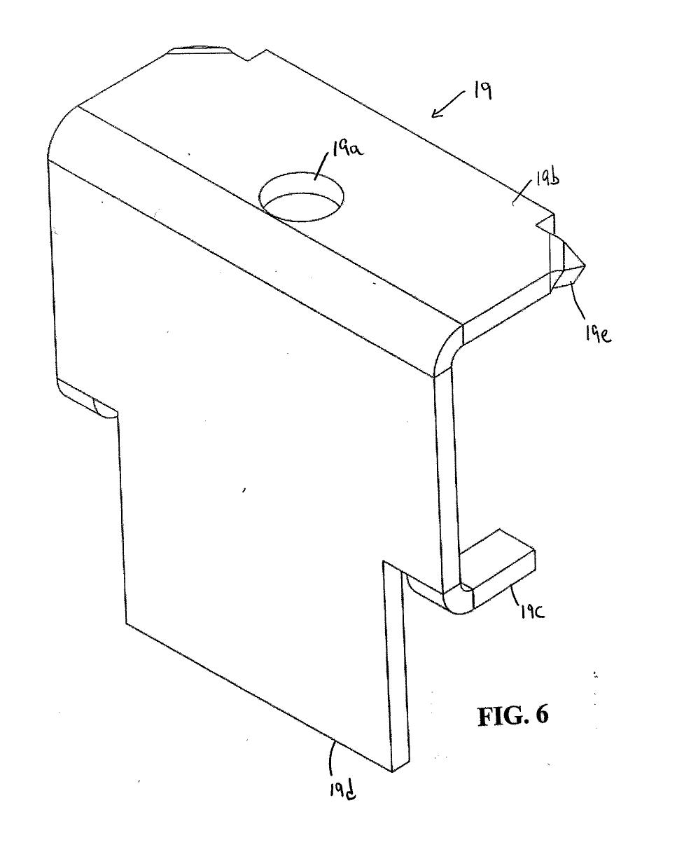

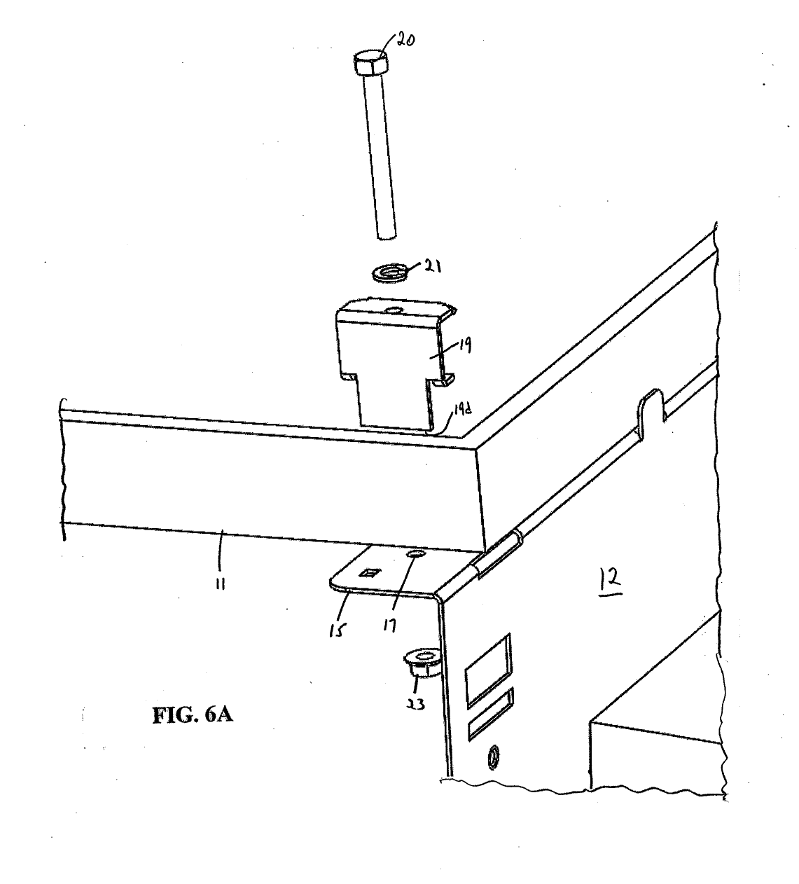

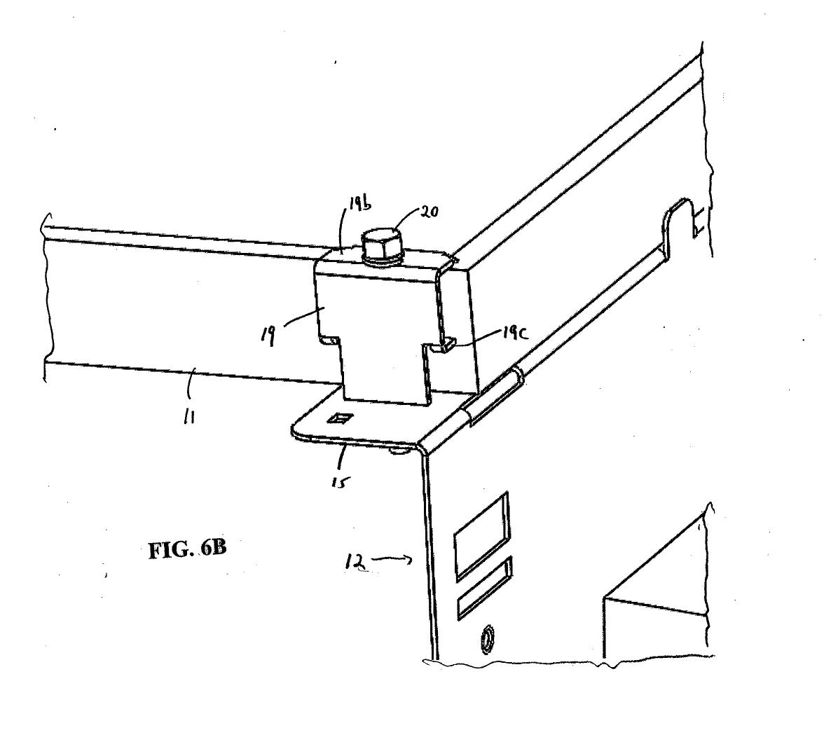

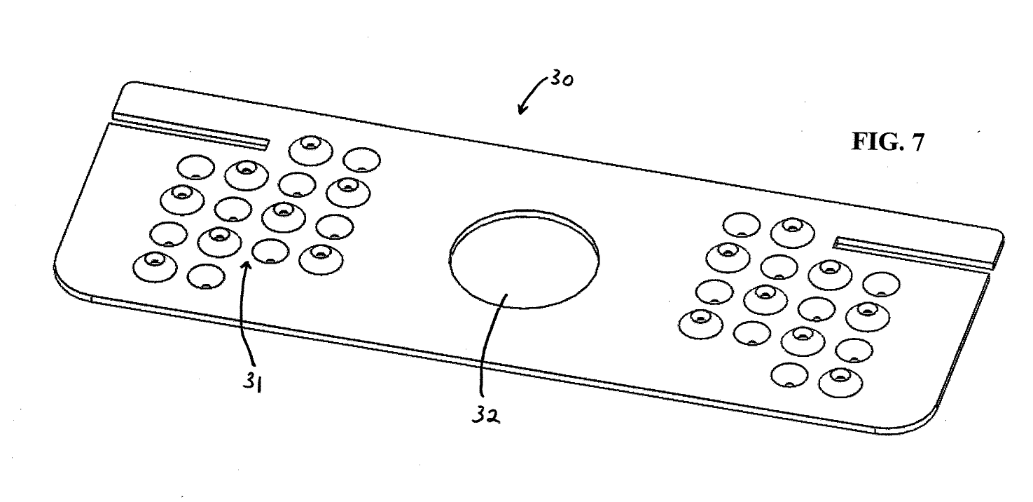

FIGS. 6, 6A and 6B similarly show the elements used in fixed placement of an end solar panel on the support pans. End panel hold down element 19 is configured to be placed at end of panel 11 and support pan 12 as shown in FIGS. 6A and 6B. As with the hold down element 18 used in between panels, end hold down element 19 is provided with a single flat edge extension 19b for holding down of panel 11 against support ledge 15. The base 19d of end hold down element is configured to rest on ledge 15 and in conjunction with buttressing support element 19c serves to prevent skewing movement of the hold down connection. Bolt 20 is similarly engaged with aperture 17 to effect the completion of the tight hold down of the panel on the support ledge 15 (or ledge 14 dependent on the edge being held down). However, as shown because of the edge placement and easier access, in addition to or in place of the threaded aperture 17 providing the bolt tightening holding, a washer and nut 21 and 23 may be further easily utilized to effect the holding of the end panel on the pan. Teeth elements 19e provide similar grounding as with teeth elements 18d.

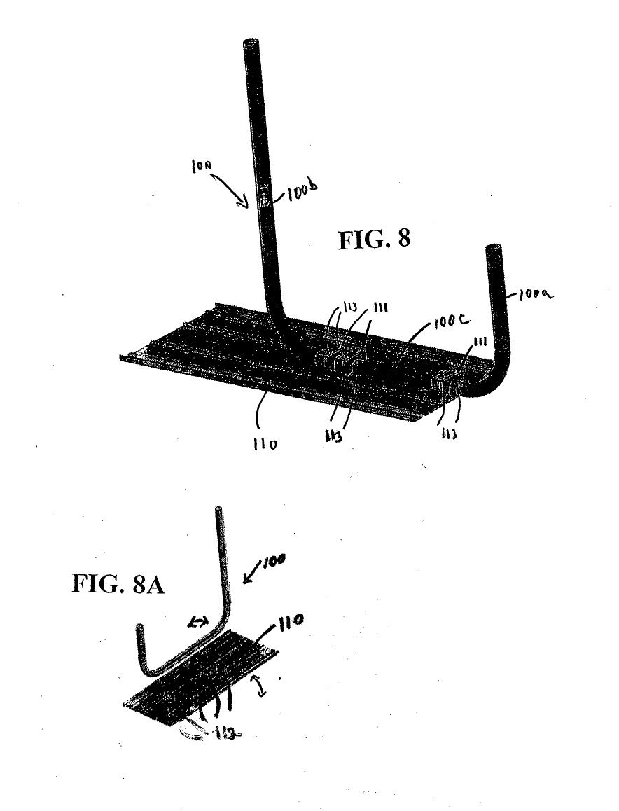

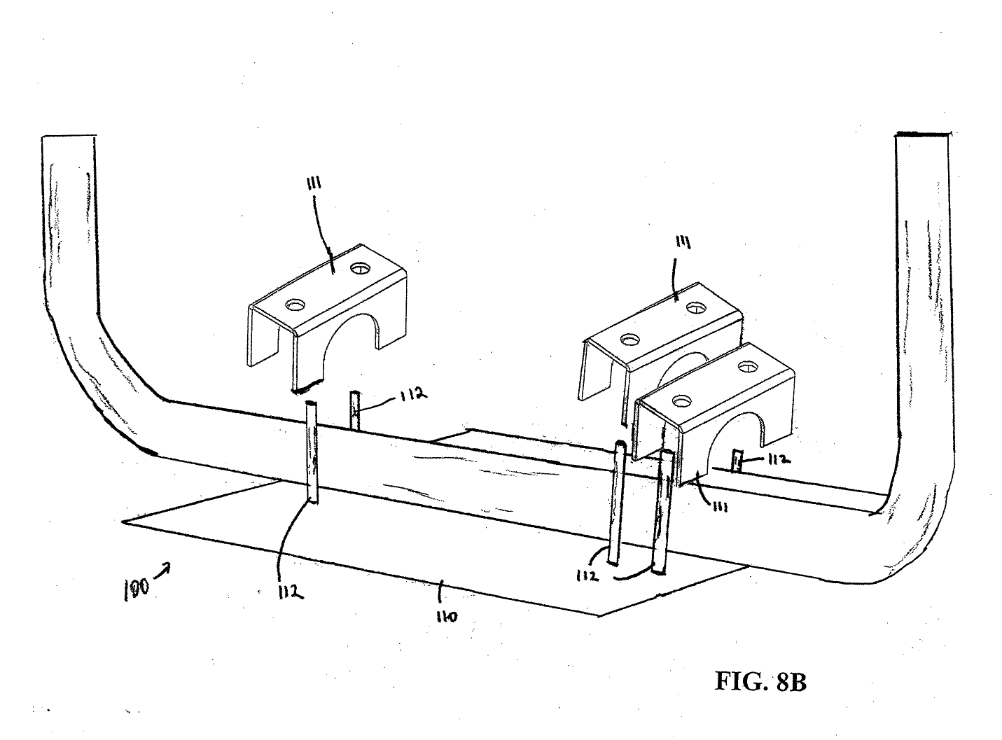

FIGS. 8, 8A and 8B depict the ground support element of a tubular element 100 with short and long sides 100a and 1130b similar to the roof support pan sides 12a and 12b. However, in contrast to roof supports resting on regular surfaces, ground supports are often placed on irregular ground surfaces. Accordingly, support plate 110 may not be level, thereby skewing the positioning of solar panel supported by tubular element 100. In order to compensate for such irregularity, the base 100c of tubular element 100 is kept tubular with a circular cross section such that it is freely movable or rotatable in lateral directions as shown by the arrows in FIGS. 8A and 8B to compensate for elevation displacement of support plate 110 shown by the movement arrows. With in situ rotation of base tube 100c into a leveling compensating position, clamps 111 are deployed with bolts 12 and nuts 113 to clamp the supporting tubing into position. In this embodiment it is also possible to provide the support plate with threaded apertures into which the bolts are downwardly tightened to effect the hold down of the support tubing 100.

It is understood that the above drawings and exemplary disclosure is not limiting and that changes may be made to the structure and components without departing from the scope of the invention as defined in the following claims.

What is claimed is:

1. A solar panel support system comprising a plurality of solar panels supportingly engaged with and connected to ledges of U-shaped weighted support pans of different heights wherein the ledges are perforated with at least two threaded apertures wherein edges of adjacent slightly spaced apart solar panels supported on a ledge of a support pan are spanned by an apertured hold down element with one of the threaded apertures being accessible, through a spacing between the slightly spaced apart solar panels, to a bolt which passes through the hold down element and into threaded engagement with the one of the threaded apertures with hold down engagement of the adjacent panels to a ledge of the pan being effected with the threaded engagement of the bolt and the threaded aperture.

2. The solar panel support system of claim 1, wherein end edges of solar panels not adjacent to other solar panels are spanned and held down by apertured end hold down elements aligned with a threaded aperture in a ledge of the pan upon which the end solar panel is resting, with a bolt passing through the aperture of the end hold down element into holding engagement with the threaded aperture and wherein the end hold down elements each comprise a buttressing extension which abuts the solar panel to thereby stabilize the holding and panel position against movement deformation.

3. The solar panel support system of claim 2, wherein at least two support pans are interconnected with a connector strip which engages cofitting portions of the support pans

4. The solar panel support system of claim 2, wherein at least one of the hold down elements and end hold down element comprise at least one tooth for engagement with the solar panel to function as a ground.

5. A solar panel support system comprising as tubular support for a plurality of solar panels wherein the tubular support includes a tubular base with as circular cross section wherein the tubular base is rotatable to compensate for uneven support beneath the solar panels.
